(19) United States
(12) Patent Application Publication
(10) Pub. No.: US 2004/0067699 A1
(43) Pub. Date: Apr. 8, 2004

(54) Electrical apparatus intended for mounting on a subframe

(76) Inventors: Roger Dumont, Benfeld (FR); Olivier Robert, Heiligenstein (FR)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/678,850

(22) Filed: Oct. 3, 2003

(30) Foreign Application Priority Data
Oct. 4, 2002 (FR) 02/12307

(51) Int. Cl. H01R 9/22

(52) U.S. Cl. 439/894

(57) ABSTRACT

The present invention relates to an electrical apparatus that is intended for mounting on an frame, allows lateral connection as well as rear connection, is simple to manufacture and use, is economical, requires little space, is reliable and meets the safety standards that are in effect.

This electrical apparatus (10) is characterized by the fact that it has connecting tabs (70, 70′) arranged for connection to said electrical terminals (80, 80′) of electrical apparatus (10) in such a way that they are removable and can be oriented in a lateral or rear position. Electrical terminals (80, 80′) have mounting zone (80a, 80′a) forming an angle α equal to 45° with rear wall (40) of casing (20), and connecting tabs (70, 70′) have connecting segment (70b, 70′b) and mounting segment (70a, 70′a) forming between them an angle β equal to 135°. Casing (20) of electrical apparatus (10) also has lateral openings (60, 60′) and rear openings (61, 61′) for the passage of connecting tabs (70, 70′), these lateral (60, 60′) and rear (61, 61′) openings being closed by cover (21).

Application: Any type of electrical apparatus, in particular switches, fuse switches, changeover switches, circuit breakers, etc.

The present invention relates to an electrical apparatus which is intended for mounting on a frame, this electrical apparatus having at least two electrical terminals housed in a casing.

Such electrical apparatuses are generally used for single phase, three phase, or four phase low voltage electrical distribution, the current ranging from a few tens to several hundred A. These can be switches, fuse switches, changeover switches, circuit breakers or any other electrical apparatus.

In a known manner, these electrical apparatuses are mounted in electrical distribution cabinets on plates or wiring frames. They are usually connected to an electrical circuit by electrical terminals that pass through the side walls of the casing and extend laterally beyond the casing. In certain configurations, however, it is necessary to connect these electrical apparatuses from the rear. In this case, L-shaped connecting tabs, called rear connections, are used that are produced specifically and to size and are connected to the projecting parts called electrical terminals. In order to comply with safety standards and to avoid any contact when an operator is working in an electrical cabinet, this solution requires the use of a specific enclosure covering the accessible part of the electrical terminals and the connecting tabs. This enclosure can interfere with heat dissipation of these electrical apparatuses which then tend to overheat, resulting in accelerated aging. In addition to this major disadvantage, it is necessary to stock all types of connecting tabs needed for all connection configurations, and to deliver the electrical apparatus accompanied by the types of connecting tabs needed by the client, resulting in a large extra cost. Furthermore, this rear connection mode involves a large lateral space requirement which limits the volume available in the electrical cabinet. This solution is therefore unsatisfactory.

The present invention aims to remedy these problems by proposing an electrical apparatus in which each electrical terminal is arranged so that it can be connected laterally as well as towards the rear, which is simple to manufacture and use, is economical, requires little space, and is reliable, and which allows use in complete safety, limits the risks of temperature rise at the site of the electrical connection, and proportionally increases the lifetime of the electrical apparatus.

With this aim, the invention relates to an electrical apparatus of the type indicated in the preamble, characterized by the fact that for each electrical terminal there is at least one tab for connection to an electrical circuit, the connecting tab being arranged for mounting on the electrical terminal so as to extend, as desired, laterally or towards the rear of the casing as a function of the configuration of connection to the electrical circuit, and by the fact that the casing has at least one lateral opening and one rear opening, made respectively in its lateral and rear walls opposite each electrical terminal.

According to a preferred embodiment, the rear and lateral openings define a single opening.

The connecting tab preferably has at least one mounting segment and at least one connecting segment, the electrical terminal has at least one mounting zone, the mounting segment and the mounting zone being arranged so as to be connected by some removable assembling means.

The mounting zone of each electrical terminal advantageously defines, with the rear wall of said casing, an angle α that is roughly equal to 45°. In the same way, the mounting segment and the connecting segment of each connecting tab advantageously define between them an angle β roughly equal to 135°.

In the preferred embodiment, the electrical apparatus has at least one removable cover arranged so as to cover a pair of rear and lateral openings, with it being possible for this cover to have a gripping component.

The cover and the casing advantageously have complementary nesting shapes provided with means of locking, for example, by snapping.

This cover is advantageously made up of two covering flaps forming an angle δ roughly equal to 90°, at least one of these covering flaps being provided with a hole arranged to receive a connecting tab.

The present invention and its advantages will appear more clearly in the following description of an embodiment, with reference to the appended drawings given as a non-limiting example, in which:

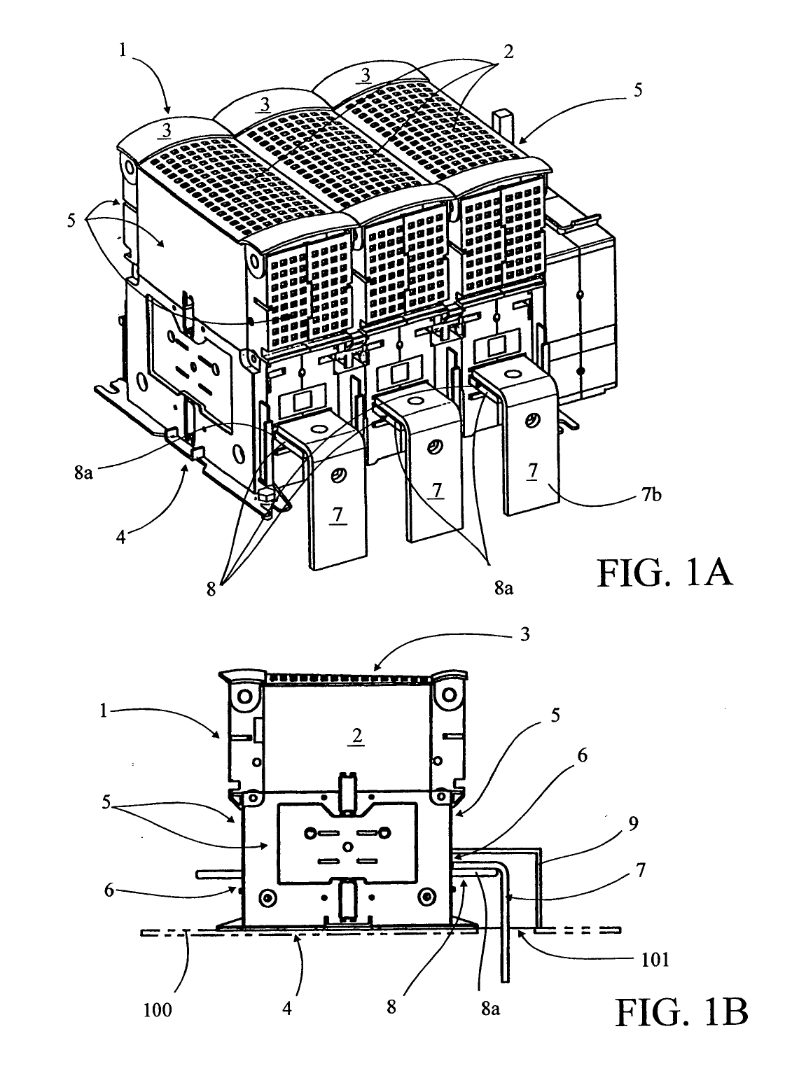

FIGS. 1A and 1B are respectively an oblique view and a side view of the three phase electrical apparatus of the prior art, illustrating the two modes of connection: lateral and rear,

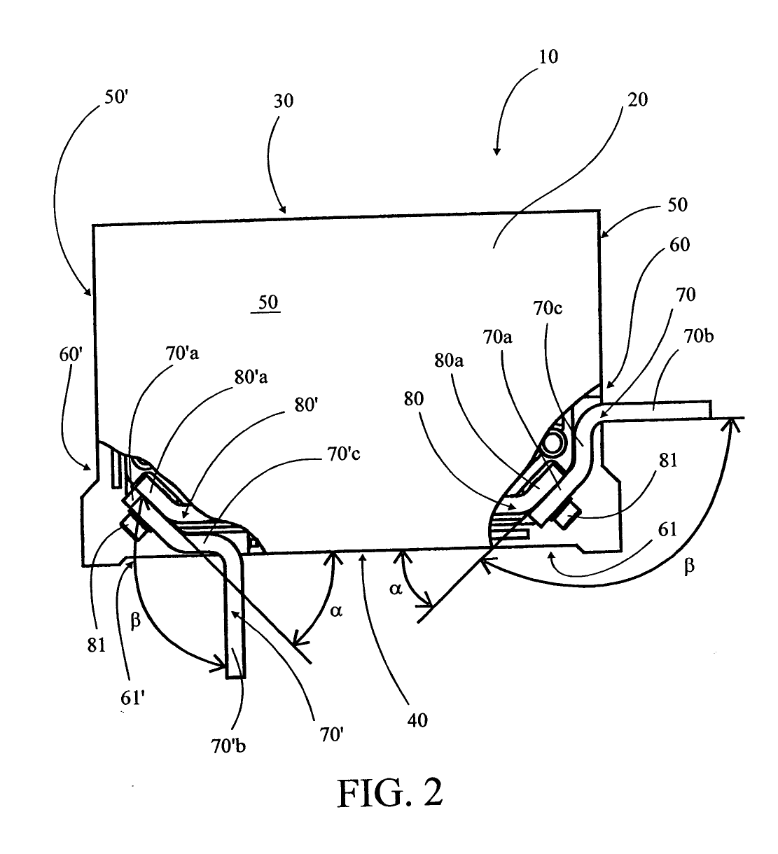

FIG. 2 is a side view of an electrical apparatus according to the invention, illustrating the two modes of connection: lateral and rear,

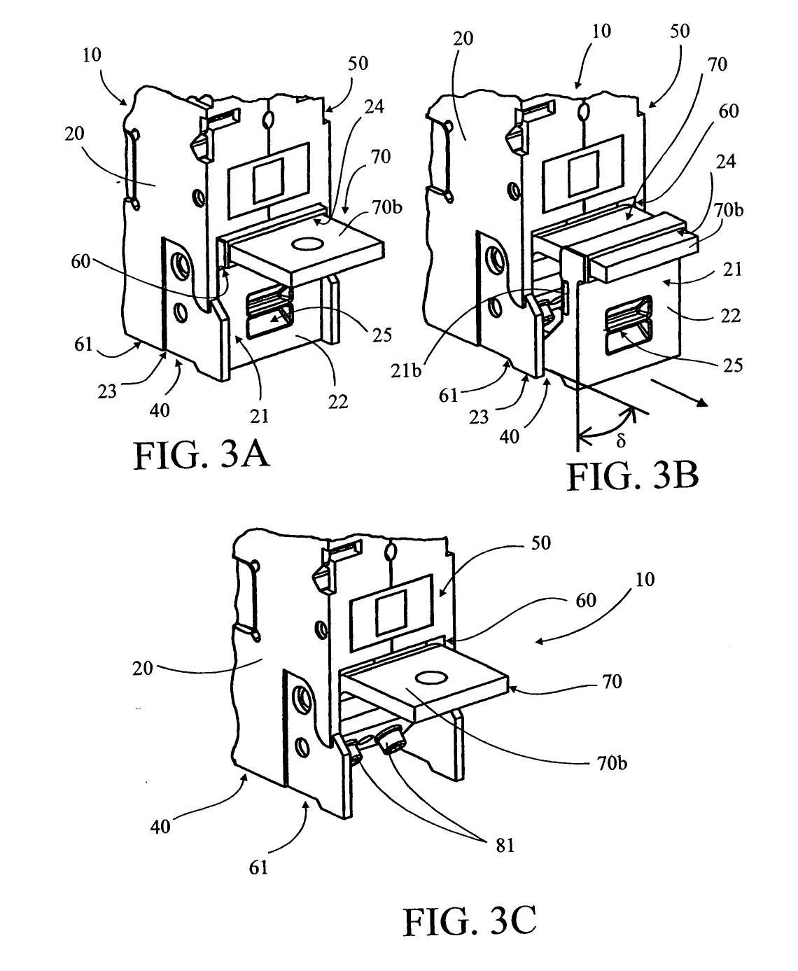

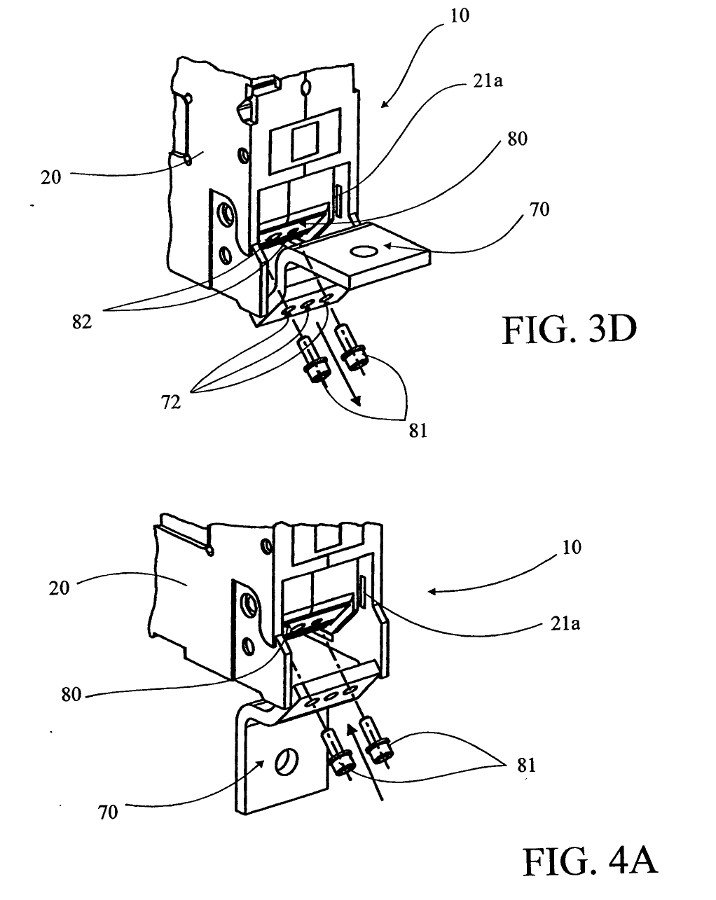

FIGS. 3A to 3D are partial oblique views of the electrical apparatus of FIG. 2, showing a connecting tab mounted in lateral position, and then the three steps of removing this connecting tab, and

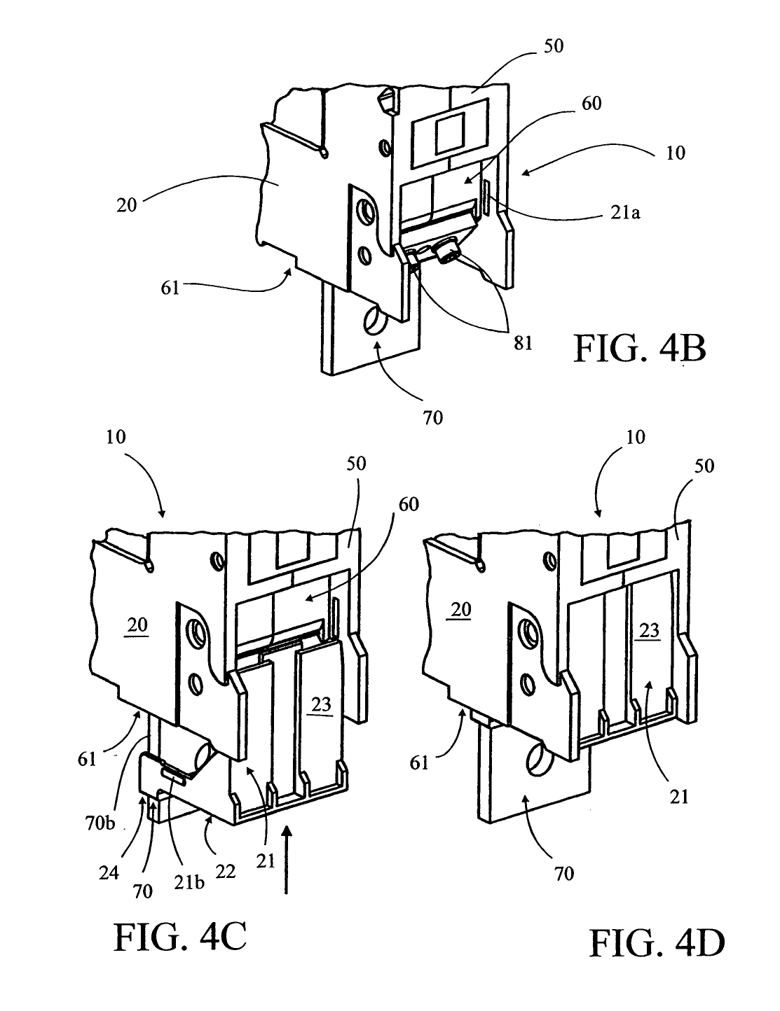

FIGS. 4A to 4D are partial oblique views of the electrical apparatus of FIGS. 3A to 3D, showing the three steps of mounting the connecting tab in rear position, and then the connecting tab mounted.

With reference to FIGS. 1A and 1B, known electrical apparatuses 1 are traditionally intended for mounting on frame 100, for example, a plate arranged in an electrical cabinet. These electrical apparatuses 1 have casing 2, which is, for example, parallelipipedic or any other suitable shape. This casing defines front wall 3 and rear wall 4 connected by four lateral walls 5, rear wall 4 being used for laying and attaching electrical apparatus 1 on frame 100. Electrical apparatus 1 has electrical terminals 8 housed in casing 2 and extending laterally beyond the casing through holes 6 whose dimensions are suited to those of electrical terminals 8.

Electrical connection of this electrical apparatus 1 is made directly on projecting parts 8a of electrical terminals 8. This electrical connection is generally lateral (left side of FIGS. 1A, 1B). In order to execute a rear connection, one uses L-shaped connecting tabs 7 that are mounted on projecting parts 8a of electrical terminals 8 (right side of FIGS. 1A, 1B). In this case, frame 100 has passageways 101 for connecting tabs 7, making it possible, for example, to achieve connection to the electrical supply bars situated behind frame 100. In order to protect the operator working in the electrical cabinet from possible contact with a conducting part, connecting tab 7 is covered by removable cover 9, which is represented in FIG. 1B mounted between casing 2 and support 100. This cover 9 is, for example, formed by a front wall and three lateral walls and made of insulating material, and can have aeration openings, not represented, that limit the temperature rise.

With reference to FIG. 2, the construction of electrical apparatus 10 according to the invention is essentially similar to that of electrical apparatus 1 of FIGS. 1A and 1B. This electrical apparatus 10 has at least two electrical terminals 80, 80′ housed in casing 20 provided with front wall 30, rear wall 40 and lateral walls 50, 50′.

This electrical apparatus 10 is differentiated from the preceding one in particular by the fact that the electrical connection is no longer made directly on electrical terminals 80, 80′ but rather via connecting tabs 70, 70′ that are added on and are removable. Depending on their orientation, they allow one to connect electrical apparatus 10 laterally (right side of FIG. 2) or towards the rear (left side of FIG. 2). In order to attain this objective, electrical terminals 80, 80′ have mounting zone 80a, 80′a which is capable of receiving said connecting tabs 70, 70′, this mounting zone 80a, 80′a forming, with rear wall 40 of casing 20, an angle α roughly equal to 45°. Connecting tabs 70, 70′ have mounting segment 70a, 70′a and connecting segment 70b, 70′b that [respectively] form between them an angle β roughly equal to 135°. Opposite each electrical terminal 80, 80′, casing 20 has lateral opening 60, 60′ and rear opening 61, 61′ that allow connecting tabs 70, 70′ to pass through.

Mounting segments 70a, 70′a of connecting tabs 70, 70′ and mounting zones 80a, 80′a of electrical terminals 80, 80′ are provided with openings 72, 82, represented in FIG. 3D, said openings 72, 82 receiving fastening screw 81 enabling connection of each connecting tab 70, 70′ to a corresponding electrical terminal 80, 80′. Connecting tabs 70, 70′ can be attached on electrical terminals 80, 80′ by any other equivalent assembling means.

In this example, connecting tabs 70, 70′ have intermediate segment 70c, 70′c arranged between mounting segment 70a, 70′a and connecting segment 70b, 70′b. This intermediate segment 70c, 70′c defines with mounting segment 70a, 70′a an angle roughly equal to 45°, and with connecting segment 70b, 70′b an angle roughly equal to 90°. This intermediate segment can, among other things, facilitate positioning of connecting tab 70, 70′ on electrical terminal 80, 80′ during mounting. It also makes it possible to limit the space requirement of connecting tab 70, 70′ outside of casing 20 while guaranteeing a fixed distance between two connecting tabs 70, 70′ mounted in rear position.

Electrical apparatus 10 also has, for each electrical terminal 80, 80′, removable L-shaped cover 21 that is capable of covering lateral 60, 60′ and rear 61, 61′ openings of casing 20. It has two covering flaps 22, 23 forming an angle δ roughly equal to 90°, which is represented in FIG. 3B. Cover 21 and casing 20 have complementary nesting shapes, for example, grooves 21a represented in FIGS. 3D, 4A and 4B and ribs 21b represented in FIGS. 3B and 4C. These complementary nesting shapes also make it possible to lock cover 21 to casing 20, by snapping, for example. One of covering flaps 22 has hole 24 arranged to receive connecting segment 70b of connecting tab 70. In this example, cover 21 has gripping component 25, for example, two indentations that can be grasped by a tool such as pliers or by two fingers of a hand.

According to an execution variant that is not shown, when electrical apparatus 10 has several poles, cover 21 allows one to increase the isolation distances between electrical terminals 80, 80′ adjacent to the two poles.

FIGS. 3A to 3D illustrates the steps removing connecting tab 70 of apparatus 10 of FIG. 2 mounted beforehand in a lateral position (cf. FIG. 3A).

In order to modify the orientation of connecting tab 70, a first step consists of withdrawing cover 21 and translating it laterally (cf. FIG. 3B). Mounting screws 81 are then accessible (cf. FIG. 3C) and can be unscrewed. Once mounting screws 81 are withdrawn (cf. FIG. 3D), connecting tab 70 is removed.

This connecting tab 70 can be turned over and mounted on the same electrical terminal 80 in rear position (cf. FIG. 4A). Mounting screws 81 are screwed in to attach connecting tab 70 to electrical terminal 80 in rear position (cf. FIG. 4B). Cover 21 is turned over (cf. FIG. 4C) and then inserted in casing 20 by translation from the rear to the front, taking care to introduce connecting segment 70b of connecting tab 70 into hole 24 of cover 21. Covering flap 22 covers rear opening 61, and covering flap 23 covers lateral opening 60 (cf. FIG. 4D.

This description shows clearly that the invention makes it possible to meet the aims that were set, in particular that this simple and economical electrical apparatus 10 can be quickly configured for lateral connection and for rear connection. Thanks to the design of this electrical apparatus 10, connecting tabs 70, 70′ can ultimately be realized by the final client who thus can optimize their shape and their length as a function of his specific electrical connection, and thus economize in terms of a screwing point.

The present invention is not limited to the embodiment that has been described, but rather extends to any modification and variant obvious to an expert in the field while remaining within the scope of the protection defined in the appended claims.

1. An electrical apparatus (10) that is intended for mounting on frame (100), this electrical apparatus (10) having at least two electrical terminals (80, 80′) housed in casing (20), characterized by the fact that it has for each electrical terminal (80, 80′) at least one tab (70, 70′) for connection to an electrical circuit, said connecting tab (70, 70′) being arranged for mounting on said electrical terminal (80, 80′) so as to extend, as desired, laterally or towards the rear of said casing (20) as a function of the configuration of connection to said electrical circuit, and by the fact that said casing (20) has at least one lateral opening (60, 60′) and at least one rear opening (61, 61′), made respectively in its lateral (50) and rear (40) walls, opposite each electrical terminal (80, 80′).

2. An electrical apparatus (10) according to claim 1, characterized by the fact that said rear (61, 61′) and lateral (60, 60′) openings define a single opening.

3. An electrical apparatus (10) according to claim 1, characterized by the fact that said connecting tab (70, 70′) has at least one mounting segment (70a, 70′a) and at least one connecting segment (70b, 70′b), by the fact that said electrical terminal (80, 80′) has at least one mounting zone (80a, 80′a), and by the fact that said mounting segment (70a, 70′a) and said mounting zone (80a, 80′a) are arranged so as to be connected by some removable assembling means (81).

4. An electrical apparatus (10) according to claim 3, characterized by the fact that said mounting zone (80a, 80′a) of each electrical terminal (80, 80′) defines, with said rear wall (40), an angle α that is roughly equal to 45°, and by the fact that said mounting segment (70a, 70′a) and said connecting segment (70b, 70′b) of each connecting tab (70, 70′) define between them an angle β roughly equal to 135°.

5. An electrical apparatus (10) according to claim 1, characterized by the fact that it has at least one removable cover (21) arranged to cover a pair of rear (61, 61′) and lateral (60, 60′) openings.

6. An electrical apparatus (10) according to claim 5, characterized by the fact that said cover (21) and said casing (20) have complementary nesting shapes.

7. An electrical apparatus (10) according to claim 6, characterized by the fact that said complementary nesting shapes are provided with means of locking (21a, 21b) by snapping of said cover (21) on said casing (20) when they are nesting one in the other.

8. An electrical apparatus (10) according to claim 7, characterized by the fact that said cover (21) is made up of two covering flaps (22, 23) forming an angle 6 roughly equal to 90°, at least one of these covering flaps (22, 23) being provided with hole (24) arranged to receive connecting tab (70, 70′).

9. An electrical apparatus (10) according to claim 5, characterized by the fact that said cover (21) has at least one gripping component (25).
